(19) United States
(12) Patent Application Publication
(10) Pub. No.: US 2026/0111182 A1
(43) Pub. Date: Apr. 23, 2026

(54) METHOD AND SYSTEM FOR GENERATING REUSABLE DATA BUILD TOOL (DBT) MODELS USING A LOW-CODE FRAMEWORK

(71) Applicant: LTI Mindtree Ltd, Mumbai (IN)

(72) Inventors: Mahesh Jadhav, Mumbai (IN); Saurabh Kamath, Mumbai (IN)

(21) Appl. No.: 19/060,832

(22) Filed: Feb. 24, 2025

(30) Foreign Application Priority Data
Oct. 23, 2024 (IN) 202421080559

(51) Int. Cl. G06F 8/34

(52) U.S. Cl. CPC G06F 8/34

(57) ABSTRACT

The disclosure provides a method and system for generating reusable Data Build Tool (DBT) models by enabling a user to design a data transformation pipeline using a low-code framework. A graphical user interface (GUI) enables the user to design a data transformation pipeline that transforms a source dataset into one or more target datasets. The data transformation pipeline includes multiple processing nodes each representing a specific transformation function and allows one or more user-defined parameters. A pipeline validation module validates the data transformation pipeline by checking configuration settings, verifying key settings, and detecting errors within the data transformation pipeline through automated analysis. An optimization engine that is operatively coupled with the pipeline validation module improves the efficiency of the data transformation pipeline, and a code generation module generates one or more reusable DBT models corresponding to the data transformation pipeline.

### FIELD

Various embodiments of the present disclosure generally relate to generating Data Build Tool (DBT) models. More particularly, the disclosure relates to a method and system for generating reusable DBT models by enabling designing of a data transformation pipeline using a low-code framework via an intuitive graphical user interface (GUI).

### BACKGROUND

In recent years, the data transformation landscape has undergone a significant shift with the introduction of the Data Build Tool (DBT). Traditionally, data pipelines followed the Extract, Transform, Load (ETL) paradigm, where data was extracted from various sources, transformed into an intermediary stage, and then loaded into a target data warehouse. This process required substantial effort in managing the transformation logic upfront, which often resulted in increased complexity, longer development cycles, and scalability challenges.

The advent of DBT introduced a more streamlined approach, facilitating the move from ETL to Extract, Load, Transform (ELT). With ELT, raw data is first loaded into the destination system, such as a data warehouse or data lake, and then transformations are applied in-place. The shift not only simplifies the overall process but also enhances efficiency by leveraging the computational power of modern data warehouses for transformations. DBT enables data teams to write modular, SQL-based transformation scripts, automating data quality checks, and making the entire data transformation process more transparent, scalable, and maintainable.

Despite the transformative advantages the DBT brings to the data transformation process, it presents significant challenges due to its code-first nature. As DBT relies heavily on SQL-based scripting for data transformation, organizations are required to invest in building and maintaining a team of skilled DBT developers. Given the growing demand for data engineers and a limited supply of experienced DBT practitioners, assembling such a team can be a daunting task. This scarcity not only increases the cost of hiring but also puts organizations at risk of being reliant on the expertise and efficiency of a small pool of developers, which could potentially slow down development cycles and innovation.

Though there exist few organizations who introduced a low-code development feature aiming to address this issue by simplifying the development process, it appears that the feature primarily adds a graphical user interface (GUI) on top of the existing code base. While this may reduce the barrier to entry for non-developers, the core issue remains: the underlying transformations still rely on how effectively a developer writes and structures their code. This implies that the organizations will continue to depend heavily on the expertise of developers, and the efficiency of the transformation processes will hinge on how well developers stay updated on evolving DBT concepts, best practices, and performance optimizations. As a result, while the low-code solution is a step forward, it may not fully address the complexities and resource demands that organizations face when adopting DBT at scale.

Current data transformation tools, particularly those reliant on DBT's code-first approach, present significant challenges for organizations. The necessity for users to possess coding expertise limits accessibility, preventing non-technical personnel from effectively engaging with data pipeline creation. This creates a barrier to efficient data management and analysis, as many organizations struggle to leverage their data assets fully due to the steep learning curve associated with coding.

There is therefore a need for a method and system for generating optimized data transformation models through an accessible platform that reduces reliance on coding expertise.

### SUMMARY

The present disclosure relates to a method and system for generating reusable Data Build Tool (DBT) models by enabling a user to build a data transformation pipeline using a low-code framework. A graphical user interface (GUI) enables the user to design a data transformation pipeline that transforms a source dataset into one or more target datasets. The data transformation pipeline includes one or more processing nodes each representing a specific transformation function and allows one or more user-defined parameters. The GUI provides real-time feedback to the user regarding the validity of processing nodes and connections as the user designs the data transformation pipeline, including visual indicators for errors or warning.

A pipeline validation module validates the data transformation pipeline by checking configuration settings, verifying key settings, and detecting errors within the data transformation pipeline through automated analysis. An optimization engine that is operatively coupled with the pipeline validation module improves the efficiency of the data transformation pipeline, and a code generation module generates one or more reusable DBT models corresponding to the data transformation pipeline.

These and other features and advantages of the present disclosure may be appreciated from a review of the following detailed description of the present disclosure, along with the accompanying figures in which like reference numerals refer to like parts throughout.

### BRIEF DESCRIPTION OF THE FIGURES

FIG. 1 is a diagram that illustrates an exemplary environment within which various embodiments of the present disclosure may function.

FIG. 2 is a diagram that illustrates a system for generation of reusable DBT models via low code framework, in accordance with an embodiment of the disclosure.

FIG. 3 is a diagram that illustrates an exemplary diagram for a method for identifying multiple target datasets and common set of transformation operations that can be reused, in accordance with an embodiment of the disclosure.

FIG. 4 is a diagram that illustrates a flow chart for a method for generation of reusable DBT models via low code framework, in accordance with an embodiment of the disclosure.

FIG. 5a - 5g are diagrams that illustrate an exemplary sequence of steps of a low-Code data transformation pipeline, in accordance with an embodiment of the disclosure.

### DETAILED DESCRIPTION

Pursuant to various embodiments, the method and system enables a user to build a data transformation pipeline using a low-code framework. A graphical user interface (GUI) enables the user to design a data transformation pipeline that transforms a source dataset into one or more target datasets. The data transformation pipeline includes one or more processing nodes each representing a specific transformation function and allows one or more user-defined parameters. The GUI provides real-time feedback to the user regarding the validity of processing nodes and connections as the user designs the data transformation pipeline, including visual indicators for errors or warning.

A pipeline validation module validates the data transformation pipeline by checking configuration settings, verifying key settings, and detecting errors within the data transformation pipeline through automated analysis. An optimization engine that is operatively coupled with the pipeline validation module improves the efficiency of the data transformation pipeline, and a code generation module generates one or more reusable DBT models corresponding to the data transformation pipeline.

In one or more embodiments, the low-code framework enables users to build and manage data transformation pipelines with minimal programming effort. The low-code framework simplifies the process of transforming raw data into structured, usable information by allowing users to define transformation logic in a user-friendly interface. Additionally, the method and system integrates with various data storage and processing platforms, facilitating seamless interaction between the transformation logic and underlying databases, data warehouses, or data lakes.

In one or more embodiments the data transformation pipeline refers to a series of processes designed to convert raw data into a more structured, meaningful format suitable for analysis and decision-making. The data transformation pipeline enables users to define and implement a sequence of transformations on raw data, guiding it through various stages of modification, and optimization. The users can define transformation steps using a low-code interface, reducing the need for technical knowledge.

In some non-limiting embodiments, the low-code framework comprises DBT models that are considered to be the core building blocks of the DBT, representing queries that transform raw data into meaningful, structured insights. A DBT model is essentially a SQL file that defines how raw data from a source system should be transformed into a clean, analytical dataset. These DBT models allow data teams to manage complex transformations, define dependencies between datasets, and ensure that only the necessary data is transformed when changes occur.

In one or more embodiments, the GUI is equipped with one or more interactive features such as for example, a drag-and-drop feature, enabling the users to visually select and position various transformation operations such as, for example, filtering, joining, aggregating, and sorting. Each transformation operation is represented by a distinct icon or module, which the users can drag from a toolbox and drop into the pipeline sequence. The GUI is designed to be intuitive, providing a seamless workflow where users can connect the modules in the desired order to reflect the logical flow of the data transformations.

In some non-limiting embodiments, the disclosed GUI may include additional input methods beyond the drag-and-drop functionality to provide a more inclusive user experience. For instance, the GUI may feature Natural Language Processing (NLP) capabilities, enabling users to design data transformation pipelines by typing instructions in natural language. The system may interpret these instructions and automatically translate them into the appropriate transformation operations on the canvas. Additionally, the GUI may support voice input, allowing users to verbally instruct the framework to build and modify the pipeline.

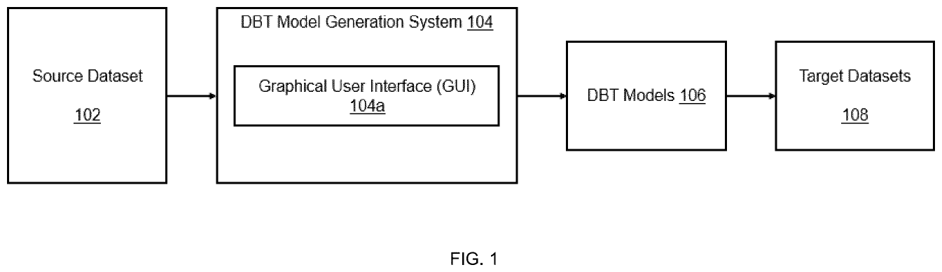

FIG. 1 is a diagram that illustrates an exemplary environment 100 within which various embodiments of the present disclosure may function. Referring to FIG. 1, the environment 100 comprises a source dataset 102, a DBT model generation system 104 with a graphical user interface (GUI) 104a, reusable DBT models 106, and one or more target datasets 108.

The source dataset 102 is defined as the starting point of the data transformation pipeline, where data is read from source tables or databases. It represents the raw data that is extracted from source tables or databases, which could be in various formats or reside in multiple locations, such as relational databases, data lakes, or third-party data sources. The source dataset may contain unstructured or semi-structured data that will undergo transformations within the low code framework.

In one or more embodiments, the source dataset 102 may include multiple different files that may have different formats and/or schemas.

The DBT model generation system 104 may comprise suitable logic, and/or interfaces, that may be configured to generate reusable DBT models 106 through a low-code framework. The DBT model generation system 104 enables the user to build a data transformation pipeline using the low-code framework and generate the DBT models 106 that are configured to be reusable.

In one or more embodiments, the low-code framework is designed to minimize the amount of hand-written code required to build applications, enabling the users to design workflows through interfaces and pre-built modules. By providing a user-friendly environment with graphical interfaces and pre-built modules, the low-code framework enables users, even those with limited programming expertise, to define, optimize, and generate the reusable DBT models 106 efficiently. The low-code framework allows users to customize the transformation steps and logic with minimal coding, leveraging the underlying system's capabilities to automatically generate the reusable DBT models 106 based on the configured parameters.

The DBT model generation system 104 further comprises an intuitive GUI 104a, that is specifically configured to enable users to design a data transformation pipeline, allowing for intuitive and efficient interaction with the transformation process. Through the GUI 104a, the users can transform a source dataset into one or more target datasets by constructing a pipeline composed of a plurality of processing nodes. Each processing node within the pipeline represents a specific transformation function, such as filtering, aggregation, or joining, and visually depicts the flow of data through the transformation stages.

In one or more embodiments, the GUI 104a simplifies the process by allowing the users to customize each processing node with user-defined parameters, enabling control over the transformations being applied to the data. For example, the users can define filter conditions, select aggregation methods, or specify how datasets are joined, all within the GUI 104a. In an instance, the GUI 104a may allow drag-and-drop functionality, enabling the users to easily add, remove, or modify processing nodes, ensuring that the data transformation pipeline is both flexible and adaptable to changing requirements.

The reusable DBT models 106 are essentially SQL files that defines the transformation logic to be applied to the data. The reusable DBT models 106 take raw data from the source dataset 102 and apply transformations to shape, clean, and prepare the data for downstream consumption. The reusable DBT models 106 are modular and interdependent, allowing the users to build layered transformations where each model can build upon the outputs of others, creating a well-structured and maintainable pipeline.

In one or more embodiments, the low-code framework in the DBT model generation system 104 is designed to optimize and streamline the creation of reusable DBT models. Once generated, the DBT models are reusable, indicating they can be applied to different target datasets or used across various pipelines with minimal modification.

The target datasets 108, as illustrated in FIG. 1, represent the final outputs produced by the DBT model generation system 104 after applying the transformation logic defined in the reusable DBT models 106. The target datasets 108 are the outputs of applying the reusable DBT models 106 to the source dataset 102. For instance, the target datasets 108 are structured and optimized for various downstream applications, such as business intelligence reporting, data analysis, or machine learning tasks.

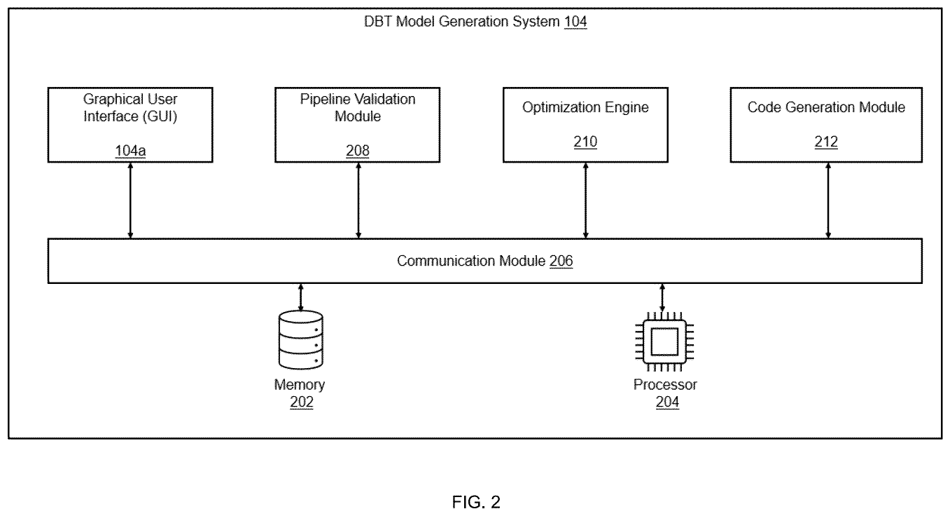

FIG. 2 is a diagram that illustrates the DBT model generation system 104 for generation of reusable DBT models via a low code framework, in accordance with an embodiment of the disclosure. Referring to FIG. 2, the DBT model generation system 104 comprises a memory 202, a processor 204, a communication module 206, a graphical user interface (GUI) 104a, a pipeline validation module 208, an optimization engine 210, and a code generation module 212.

The memory 202 may comprise suitable logic, and/or interfaces, that may be configured to store instructions (for example, computer-readable program code) that can implement various aspects of the present disclosure.

The processor 204 may comprise suitable logic, interfaces, and/or code that may be configured to execute the instructions stored in the memory 202 to implement various functionalities of the DBT model generation system 104 in accordance with various aspects of the present disclosure. The processor 204 may be further configured to communicate with various modules of the DBT model generation system 104 via the communication module 206.

The communication module 206 may comprise suitable logic, interfaces, and/or code that may be configured to transmit data between modules, engines, databases, memories, and other components of the DBT model generation system 104 for use in performing functions discussed herein. The communication module 206 may include one or more communication types and utilizes various communication methods for communication within the DBT model generation system 104.

The GUI 104a may comprise suitable logic, interfaces, and/or code that may be configured to enable the user with an intuitive platform for designing a data transformation pipeline that efficiently transforms the source dataset 102 into the one or more target datasets 108.

In one or more embodiments, the data transformation pipeline comprises a plurality of processing nodes, each representing a specific transformation function essential to the overall data processing workflow. The processing nodes serve as building blocks of the data transformation pipeline, enabling the user to define various data operations such as filtering, aggregating, joining, and sorting. In an instance, by simply dragging and dropping these nodes into the pipeline, users can easily sequence transformations to meet specific data processing needs.

In one or more embodiments, the GUI 104a is designed to enhance user interaction and engagement while creating data transformation pipelines by providing real-time feedback on the validity of processing nodes and their connections.

In an exemplary embodiment, when the user drags and drops processing nodes, the GUI 104a continuously analyzes the configuration and interconnections of these nodes. Assesses whether the selected nodes are appropriately configured and compatible with one another, taking into account factors such as data types, required parameters, and logical flow. The ongoing validation process enables the DBT model generation system 104 to detect discrepancies or misconfigurations in real-time, allowing the user to make immediate corrections rather than discovering issues during or after the execution of the pipeline.

In accordance with the exemplary embodiment, to facilitate the feedback, the GUI 104a incorporates visual indicators that clearly communicate the status of each processing node and the connections between them. For example, the processing nodes that are correctly configured may be highlighted in green, while those that contain errors could be marked in red. Additionally, warnings about potential issues such as mismatched data types or missing parameters can be displayed using yellow indicators or icons.

In some non-limiting embodiments, when the user hovers over a processing node or connection with an error or warning, the GUI 104a may display tooltips or pop-up messages detailing the specific nature of the issue. The context-sensitive information allows the user to understand the problem and make informed decisions on how to resolve it. By providing clear, intuitive visual feedback, the GUI 104a fosters a more efficient and user-friendly design experience, enabling the user to construct robust data transformation pipelines with confidence and ease.

Moreover, the GUI 104a allows for customization of each processing node through user-defined parameters, allowing the user to tailor the transformation logic to suit the requirements. For instance, the user might specify certain conditions for filtering data or set parameters for aggregation, such as summing or averaging specific fields. The configurability enhances the pipeline's adaptability, enabling the user to modify transformation logic on-the-fly as new data requirements arise or as insights evolve.

In one or more embodiments, the GUI 104a can be an AI-powered interface, enhancing the user experience by providing intelligent assistance and automation throughout the pipeline design process. The AI-based GUI 104a comprises suitable logic, interfaces, and/or code that are configured not only to allow users to design a data transformation pipeline with ease but also to offer smart recommendations, and automated optimization. The AI-based GUI 104a retains its drag-and-drop functionality, enabling the users to visually select and position transformation operations such as filtering, joining, aggregating, and sorting onto a canvas.

In some non-limiting embodiments, with the integration of AI, the GUI 104a may automatically create the optimal sequence of transformations based on data patterns, usage history, and best practices, thus reducing manual effort. For example, when a user configures a filter node and selects the join keys from the input datasets, the AI may analyze the join keys and recommend using more appropriate keys instead of the ones selected by the user to avoid errors or performance issues. This guidance ensures improved accuracy and efficiency in the pipeline design process. Additionally, the AI-powered GUI 104a may detect potential errors in real-time, such as incompatible data types or inefficient transformation sequences, and offer corrective suggestions to ensure the accuracy and efficiency of the pipeline.

The pipeline validation module 208 may comprise suitable logic, interfaces, and/or code that is configured to ensure the integrity and correctness of the data transformation pipeline before it is executed. The pipeline validation module 208 performs comprehensive validation checks that are essential for preventing errors and ensuring that the transformation processes will function as intended.

In one or more embodiments, the validation process by the pipeline validation module 208 begins with examination of the configuration settings within the data transformation pipeline. This includes verifying that all necessary parameters and options have been correctly defined and set according to the specified requirements. The pipeline validation module 208 systematically checks for inconsistencies, such as incorrect data types, missing values, or improperly configured transformation functions. By confirming that all configuration settings are accurate and complete, the pipeline validation module 208 helps prevent potential issues that could arise during execution.

In addition to configuration checks, the pipeline validation module 208 verifies key settings that are pivotal to the successful execution of the data transformation pipeline. This may involve ensuring that source dataset and the target datasets are correctly specified, checking the connectivity to data sources, and confirming that any required permissions or access rights are in place. By meticulously verifying these key settings, the pipeline validation module 208 minimizes the risk of runtime errors that could disrupt the data transformation process.

Furthermore, the pipeline validation module 208 employs one or more automated analysis techniques to detect errors within the data transformation pipeline. The automated analysis may involve simulating the execution of the pipeline to identify logical errors, data inconsistencies, or potential bottlenecks that could affect performance. For instance, the pipeline validation module 208 may analyze the flow of data through processing nodes to ensure that outputs are correctly mapped to subsequent inputs, thereby preventing cascading errors.

In one or more embodiments, the pipeline validation module 208 is also configured to provide validation error messages to the user via the GUI 104a to ensure that user is promptly informed of any issues that may arise during the design phase, facilitating quick resolutions and preventing downstream problems during execution. When the user designs the data transformation pipeline, the pipeline validation module 208 continuously monitors the configuration and interactions between processing nodes. If it detects any inconsistencies or errors such as incorrect parameter settings, incompatible data types, or missing connections it generates specific validation error messages that are immediately communicated to the user through the GUI 104a.

In one or more embodiments, the validation error messages can vary in severity, allowing the GUI 104a to differentiate between critical errors that require immediate attention and warnings that indicate potential improvements or best practices. The tiered approach to error messaging helps the user prioritize actions, addressing critical issues first while also being aware of less severe warnings that could enhance the efficiency or reliability of the pipeline.

In an exemplary embodiment, the pipeline validation module 208 can include suggestions for corrective actions within the error messages. For instance, if a user attempts to connect two incompatible data types, the error message might not only indicate the problem but also recommend an alternative data type or suggest modifications to the pipeline design.

The optimization engine 210 may comprise suitable logic, interfaces, and/or code that is configured to improve efficiency of the data transformation pipeline. The optimization engine 210 may evaluate various aspects of the data transformation pipeline, such as data flow management, previous execution speed, and resource utilization. By evaluating, the optimization engine 210 can pinpoint bottlenecks, redundancies, or inefficiencies that may hinder performance. For instance, the optimization engine 210 may also recommend optimum resource that needs to be utilized for processing the data. For example, the optimization engine 210 may identify stages in the data transformation pipeline where data is unnecessarily duplicated or where processing tasks could be consolidated to reduce overall execution time.

In some non-limiting embodiments, the optimization engine 210 may incorporate interfaces that facilitate user interaction and configuration. These interfaces allow the user to easily visualize performance metrics, understand the impact of different processing strategies, and make informed decisions about potential optimizations.

In one or more embodiments, the optimization engine 210 may leverage various optimization algorithms to enhance the efficiency of the data transformation pipeline significantly. The optimization algorithms are designed to analyze and refine the processes involved in data transformation, ensuring that resources are utilized effectively and that data flows smoothly through the pipeline.

In an exemplary embodiment, the optimization engine 210 may detect when a filter operation is placed after a join and suggest or automatically move the filter ahead of the join to reduce unnecessary data processing. By intelligently optimizing the data transformation pipeline's structure and execution logic, the optimization engine 210 ensures that the data transformations are executed in the most efficient manner, reducing computation time and resource usage.

In some non-limiting embodiments, the optimization algorithms used by the optimization engine 210 can be such as, but not limited to, greedy algorithms, dynamic programming algorithms, genetic algorithms, simulated annealing techniques, and particle swarm optimization techniques to systematically improve the efficiency of the data transformation pipeline.

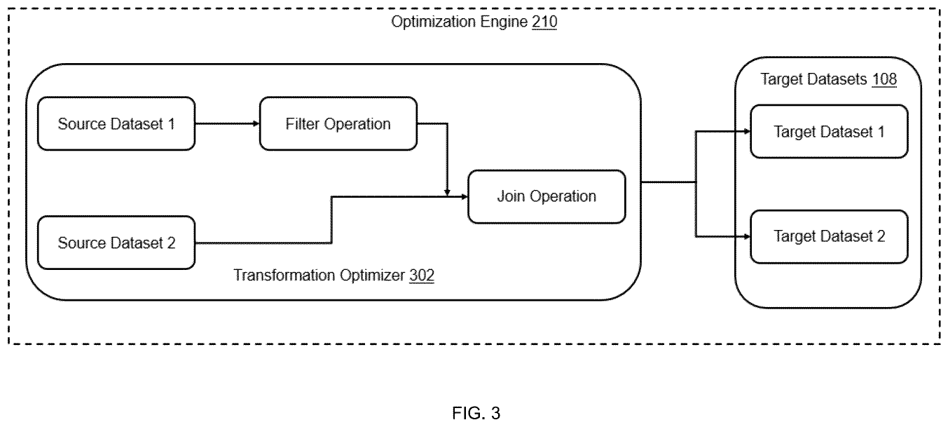

In one or more embodiments, the optimization engine 210 may utilize a transformation optimizer 302 (which is further explained in conjunction with FIG. 3) that is configured to identify one or more target datasets (target dataset 1 and target dataset 2) within the data transformation pipeline. The data pipeline may consist of source datasets, process nodes, and target datasets, each tagged accordingly to help the transformation optimizer 302 distinguish between them.

In one or more embodiments, the optimization engine 210 optimizes the data transformation pipeline by generating recommendations to the user for adjusting processing nodes or by automatically reordering the transformation operations based on historical performance metrics to optimize execution time.

As the user designs data transformation pipeline, the optimization engine 210 continuously monitors and analyzes the configurations of the processing nodes, evaluating factors such as performance, resource utilization, and interdependencies. Based on the real-time analysis, the optimization engine 210 can identify opportunities for optimization such as suggesting that a user replace a particular node with a more efficient alternative or adjust parameters to enhance its performance.

For instance, if the optimization engine 210 detects that a specific transformation node consistently leads to longer execution times in previous runs, it might recommend optimizing the processing node's configuration or even replacing it with a different transformation function that achieves the same results more efficiently.

In addition to generating recommendations, the optimization engine 210 automatically reorders transformation operations within the data transformation pipeline. By leveraging historical performance metrics collected from previous executions, the optimization engine 210 can analyze how different sequences of operations impact execution time and resource usage. The data-driven approach allows the optimization engine 210 to identify optimal ordering strategies that minimize processing delays and improve throughput.

In an exemplary embodiment, the optimization engine 210 determines that certain operations such as data filtering should be executed earlier in the data transformation pipeline to reduce the volume of data processed in subsequent operations. By autonomously reordering these operations based on empirical data, the optimization engine 210 ensures that the data transformation pipeline operates at peak efficiency, significantly reducing overall execution time.

The code generation module 212 may comprise suitable logic, interfaces, and/or code that is configured to generate one or more reusable DBT models 106 corresponding to the data transformation pipeline. Once the optimization engine 210 has refined the data pipeline for maximum efficiency, the code generation module 212 translates the final sequence of transformation operations into DBT code. The code generation module 212 ensures that each transformation step such as filtering, joining, and aggregating is accurately reflected in the reusable DBT models 106, adhering to the syntax and structure required by DBT frameworks.

In one or more embodiments, the code generation module 212 is responsible for converting the visually designed data transformation pipeline into executable DBT models, enabling the user to seamlessly transition from pipeline design to deployment without manual coding.

In one or more embodiments, the code generation module 212 leverages an ANSI SQL dictionary to generate one or more reusable DBT models 106, ensuring that the reusable DBT models 106 are compatible with various data stores by correctly mapping SQL functions at runtime based on the selected data store such as for example, Snowflake, Databricks, etc. The ANSI SQL dictionary comprises a mapping table that holds a list of standard ANSI SQL functions alongside their corresponding data store-specific equivalents. The mapping table acts as a reference point for ensuring cross-platform compatibility during the generation of DBT models.

At runtime, when the user selects a specific data store, the DBT model generation system 104 resolves which function to use based on the selected data store. The code generation module 212 accesses the ANSI SQL dictionary to translate the transformation logic into optimized DBT code that is fully compatible with the user's chosen data store. The mapping ensures that the DBT models can seamlessly adapt to various environments without requiring manual intervention to address function name differences, thus streamlining the process of pipeline creation and execution across different platforms.

In an exemplary embodiment, the code generation module 212 utilizes the ANSI SQL dictionary to ensure seamless compatibility of DBT models with various data stores. The ANSI SQL dictionary serves as a crucial component within the code generation module 212, enabling the generation of DBT models that can adapt to platform-specific variations in SQL functions.

In one or more embodiments, the DBT model generation system 104 includes a DBT storage module that enhances reusability of transformation operations within the data transformation pipeline. The DBT storage module identifies and stores a common set of transformation operations from the data transformation pipeline into intermediate models, which can be reused across multiple target datasets 108.

In one or more embodiments, the DBT storage module is configured to monitor various transformation operations applied within the data transformation pipeline. As the user designs the data transformation pipelines, the DBT storage module captures the details of the operations, including specific functions, parameters, and configurations used. By identifying patterns and commonalities in the transformation logic, the DBT storage module can consolidate these operations into a library of intermediate models. The library serves as a repository of reusable components that the user can easily access and incorporate into future pipeline designs.

In addition to storing these intermediate models, the DBT storage module may generate a metadata catalog that is instrumental in facilitating the selection of common operations based on past user designs. By maintaining a record of previously executed transformations, the metadata catalog allows the user to quickly identify and retrieve frequently used operations that align with the current needs.

The metadata catalog can include various attributes, such as operation types, frequency of use, performance metrics, and user ratings. The information enables the user to make informed decisions when selecting transformation operations.

In one or more embodiments, a rule metrics module is configured to analyze the common set of transformation operations stored in the DBT storage module to maintain a dynamic database of optimization rules that provide the user with strategic guidance on the optimal groupings and sequences for the identified transformation operations, leveraging insights gleaned from performance data collected from previous executions.

As the user designs and executes data transformation pipelines, the rule metrics module continuously gathers and analyzes performance data, including metrics such as execution time, resource consumption, and error rates associated with various transformation operations. By applying data analytics techniques to this historical performance data, the rule metrics module identifies patterns and trends that indicate which combinations of transformation operations yield the best performance. For example, it may reveal that certain operations work more efficiently when grouped together or that specific sequences of operations minimize data processing time.

Based on the analysis, the rule metrics module generates and maintains a dynamic database of optimization rules that suggests the effective ways to group and sequence transformation operations to optimize the overall performance of the data transformation pipeline. For instance, the rule metrics module might recommend that a particular set of data filtering operations be performed before aggregation tasks to reduce the volume of data being processed, thereby speeding up execution times.

In an exemplary embodiment, the recommendations from the rule metrics module can be presented directly within the GUI 104a, allowing the user to easily access and implement suggested optimizations while designing data transformation pipelines.

FIG. 3 is a diagram that illustrates an exemplary diagram 300 for a method for identifying multiple target datasets and common set of transformation operations that can be reused, in accordance with an embodiment of the disclosure.

As illustrated in FIG. 3, when a data transformation pipeline contains multiple target datasets 108, the transformation optimizer 302 identifies a common set of transformation operations that can be reused. The transformation optimizer 302 detects the common logic between the target datasets 108 and generates intermediate models to avoid redundant computations. For instance, if the same set of transformations is applied to each node of the target datasets 108, the transformation optimizer 302 creates an intermediate model that represents the shared transformation logic.

In one or more embodiments, the intermediate model representing the shared transformation logic is stored in the DBT storage module. The intermediate model is a temporary table, allowing the DBT model generation system 104 to reuse the result across different nodes of the target nodes 304, thereby enabling the DBT model generation system 104 to reduce processing time and resource consumption, optimizing the overall pipeline execution.

In one or more embodiments, the transformation optimizer 302 employs a set of deterministic rules, referred to as a rule metric, to determine which processing nodes in the data transformation pipeline can be merged. These rules establish the conditions under which transformation operations can be combined, while ensuring that operations are executed in the correct order.

In an exemplary embodiment, the rule metric specifies that narrow operations like filtering or sorting can be merged, whereas wide operations like joins or group-by must be handled separately. The transformation optimizer 302 continuously merges compatible operations until it encounters a wide operation, at which point it terminates the merge and creates a separate Common Table Expression (CTE) for that portion of the pipeline. The rule metric is maintained as an N×N matrix and is referenced during runtime to facilitate the merging process. The matrix is designed to be extensible, allowing for the easy addition of new operations as needed.

In an exemplary embodiment, the narrow operations, such as filtering and sorting, can be performed independently on each data partition, without the need for inter-partition communication. These operations tend to be highly parallelizable, making them ideal for merging in order to optimize performance. In the exemplary embodiment described, narrow operations are seamlessly merged by the transformation optimizer 302, which continuously consolidates compatible operations to minimize redundancy and streamline the pipeline.

In an exemplary embodiment, the wide operations involve the exchange of data between partitions, making them more complex and resource-intensive compared to narrow operations. As a result, the transformation optimizer 302 handles wide operations separately, creating distinct CTEs when such operations are encountered in the pipeline. The separation ensures that wide operations are managed in a way that preserves data integrity and performance. The rule metric used to govern the merging process is stored in an N×N matrix, which can be extended to accommodate new operations as needed.

In one or more embodiments, the transformation optimizer 302 traverses the user-designed data transformation pipeline and identifies transformation operations that can be merged according to the rule metric. Once the rules are established, the transformation optimizer 302 processes each transformation in sequence, analyzing the relationships between consecutive nodes. If the rule metric allows the transformation optimizer 302 merges the operations into a single query or transformation step, thereby improving the performance of the pipeline. For example, a filter operation placed after a join can be merged to reduce the overall complexity and execution time of the query. The traversal process ensures that the pipeline is as efficient as possible, while maintaining the logical flow of the transformations.

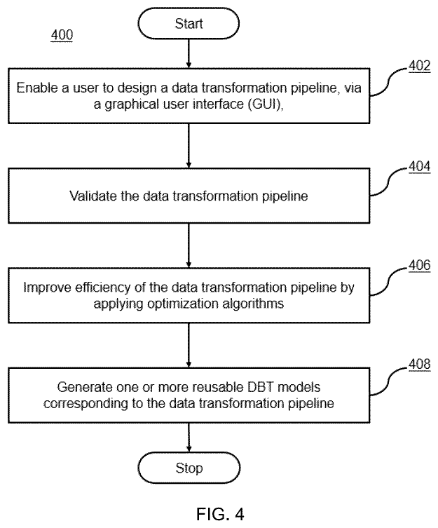

FIG. 4 is a diagram that illustrates a flow chart 400 for a method for generation of reusable DBT models via low code framework, in accordance with an embodiment of the disclosure.

At 402, the method enables a user to design a data transformation pipeline, via the GUI 104a, that transforms a source dataset into one or more target datasets.

In one or more embodiments, the data transformation pipeline comprises a plurality of processing nodes, each representing a specific transformation function essential to the overall data processing workflow. The processing nodes serve as building blocks of the data transformation pipeline, enabling the user to define various data operations such as filtering, aggregating, joining, and sorting. In an instance, by simply dragging and dropping these nodes into the pipeline, users can easily sequence transformations to meet specific data processing needs.

In one or more embodiments, the GUI 104a is designed to enhance user interaction and engagement while creating data transformation pipelines by providing real-time feedback on the validity of processing nodes and their connections.

In an exemplary embodiment, when the user drags-and-drops processing nodes, the GUI 104a continuously analyzes the configuration and interconnections of these nodes. Assesses whether the selected nodes are appropriately configured and compatible with one another, taking into account factors such as data types, required parameters, and logical flow. The ongoing validation process enables the DBT model generation system 104 to detect discrepancies or misconfigurations in real-time, allowing the user to make immediate corrections rather than discovering issues during or after the execution of the pipeline.

At 404, the pipeline validation module 208 validates the data transformation pipeline. The pipeline validation module 208 performs comprehensive validation checks that are essential for preventing errors and ensuring that the transformation processes will function as intended.

In one or more embodiments, the validation process by the pipeline validation module 208 begins with examination of the configuration settings within the data transformation pipeline. This includes verifying that all necessary parameters and options have been correctly defined and set according to the specified requirements. The pipeline validation module 208 systematically checks for inconsistencies, such as incorrect data types, missing values, or improperly configured transformation functions. By confirming that all configuration settings are accurate and complete, the pipeline validation module 208 helps prevent potential issues that could arise during execution.

In addition to configuration checks, the pipeline validation module 208 verifies key settings that are pivotal to the successful execution of the data transformation pipeline. This may involve ensuring that source dataset and the target datasets are correctly specified, checking the connectivity to data sources, and confirming that any required permissions or access rights are in place. By meticulously verifying these key settings, the pipeline validation module 208 minimizes the risk of runtime errors that could disrupt the data transformation process.

Furthermore, the pipeline validation module 208 employs one or more automated analysis techniques to detect errors within the data transformation pipeline. The automated analysis may involve simulating the execution of the pipeline to identify logical errors, data inconsistencies, or potential bottlenecks that could affect performance. For instance, the pipeline validation module 208 may analyze the flow of data through processing nodes to ensure that outputs are correctly mapped to subsequent inputs, thereby preventing cascading errors.

At 406, the data transformation pipeline is optimized by the optimization engine 210 by applying optimization algorithms.

The optimization engine 210 may evaluate various aspects of the data transformation pipeline, including processing speed, resource utilization, and data flow management. By evaluating, the optimization engine 210 can pinpoint bottlenecks, redundancies, or inefficiencies that may hinder performance. For example, the optimization engine 210 may identify stages in the data transformation pipeline where data is unnecessarily duplicated or where processing tasks could be consolidated to reduce overall execution time.

In some non-limiting embodiments, the optimization engine 210 may incorporate interfaces that facilitate user interaction and configuration. These interfaces allow the user to easily visualize performance metrics, understand the impact of different processing strategies, and make informed decisions about potential optimizations.

In one or more embodiments, the optimization engine 210 may leverage various optimization algorithms to enhance the efficiency of the data transformation pipeline significantly. The optimization algorithms are designed to analyze and refine the processes involved in data transformation, ensuring that resources are utilized effectively and that data flows smoothly through the pipeline.

Finally at 408, one or more reusable DBT models corresponding to the data transformation pipeline are generated using the code generation module 212. Once the optimization engine 210 has refined the data pipeline for maximum efficiency, the code generation module 212 translates the final sequence of transformation operations into DBT code. The code generation module 212 ensures that each transformation step such as filtering, joining, and aggregating is accurately reflected in the generated DBT models, adhering to the syntax and structure required by DBT frameworks.

In one or more embodiments, the code generation module 212 is responsible for converting the visually designed data transformation pipeline into executable DBT models, enabling the user to seamlessly transition from pipeline design to deployment without manual coding.

In one or more embodiments, the code generation module 212 leverages an ANSI SQL dictionary to generate one or more reusable DBT models 106, ensuring that the generated DBT models are compatible with various data stores by correctly mapping SQL functions at runtime based on the selected data store such as for example, Snowflake, Databricks, etc. The ANSI SQL dictionary comprises a mapping table that holds a list of standard ANSI SQL functions alongside their corresponding data store-specific equivalents. The mapping table acts as a reference point for ensuring cross-platform compatibility during the generation of DBT models.

At runtime, when the user selects a specific data store, the DBT model generation system 104 resolves which function to use based on the selected data store. The code generation module 212 accesses the ANSI SQL dictionary to translate the transformation logic into optimized DBT code that is fully compatible with the user's chosen data store. The mapping ensures that the generated DBT models can seamlessly adapt to various environments without requiring manual intervention to address function name differences, thus streamlining the process of pipeline creation and execution across different platforms.

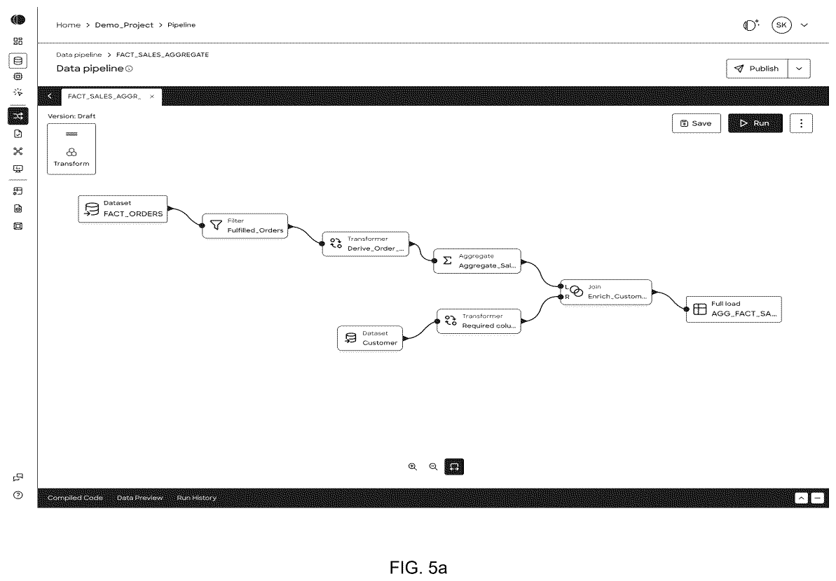

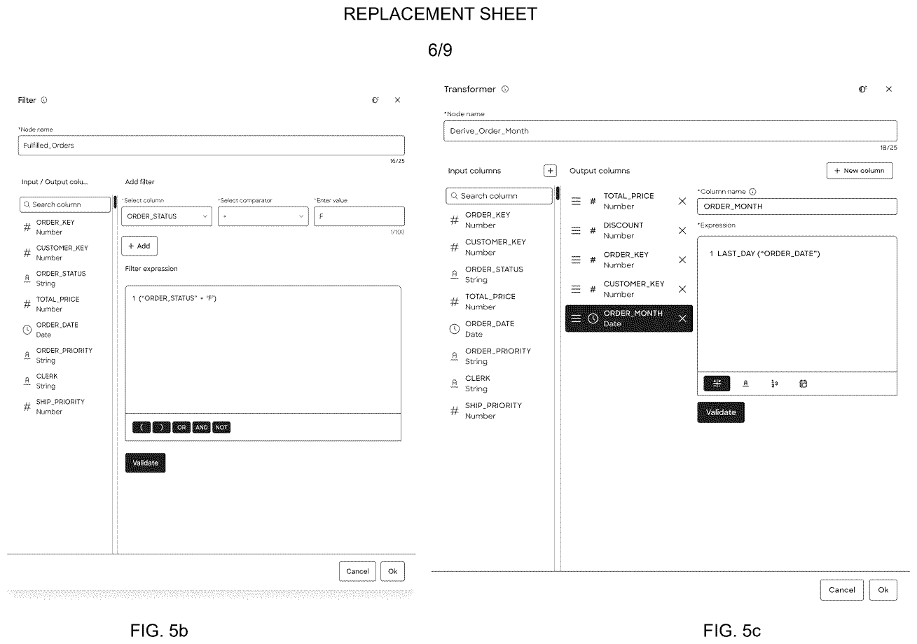

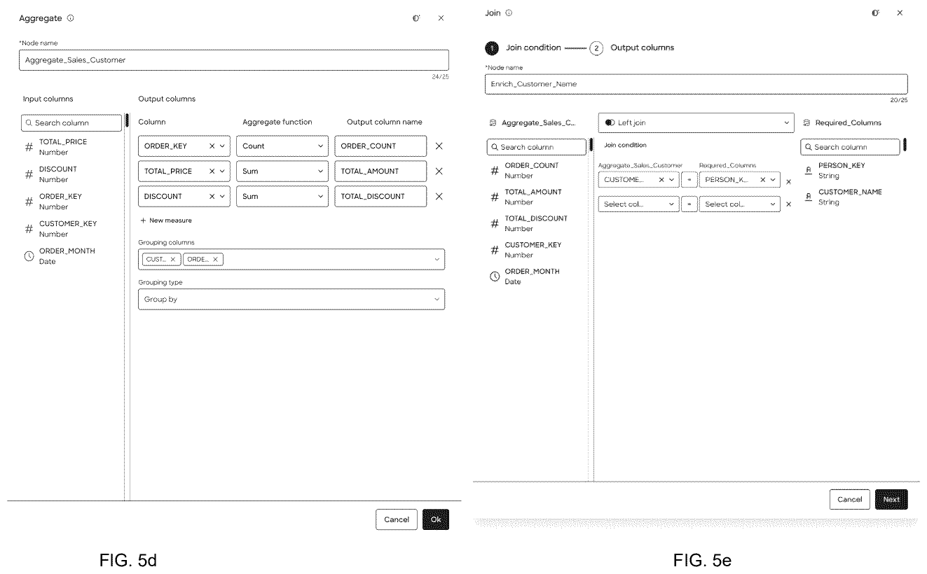

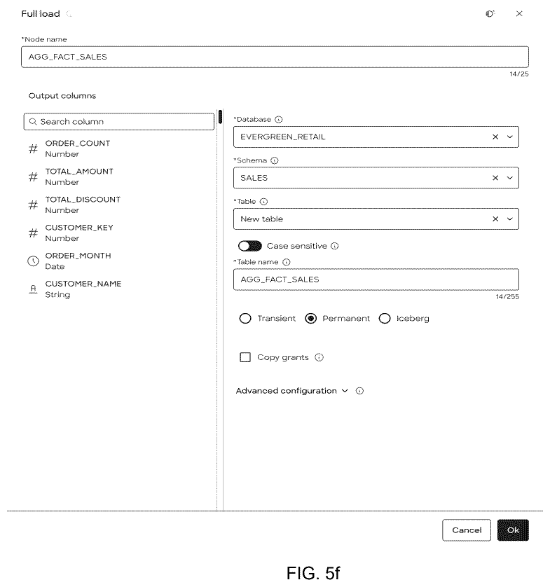

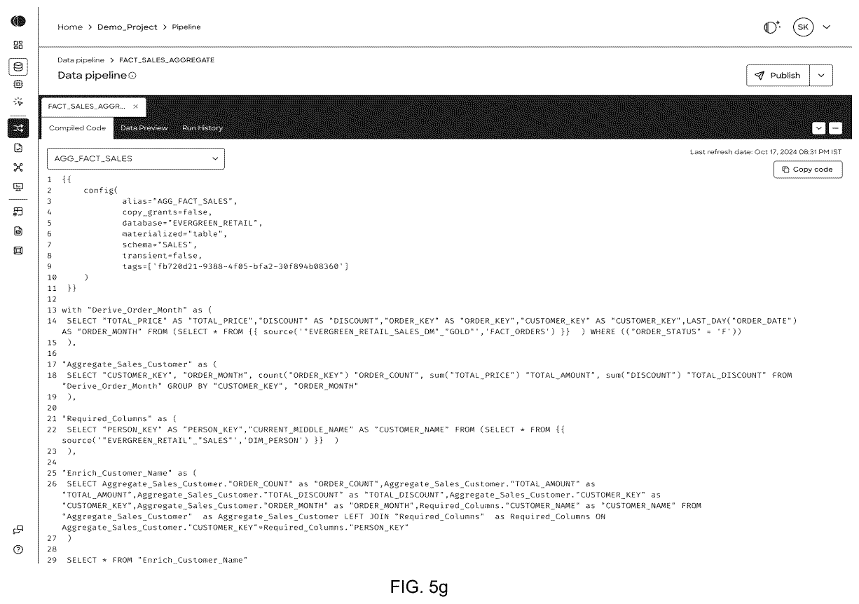

FIG. 5a - 5g are diagrams that illustrate an exemplary sequence of steps of a low-Code data transformation pipeline, in accordance with an embodiment of the disclosure.

FIG. 5a demonstrates the process of compiling monthly sales order data per customer. The pipeline, constructed using a low-code framework, allows users to visually design data transformations through a series of processing nodes, each representing a specific function with minimal need for hand-written code.

As illustrated in FIG. 5b, the pipeline begins with a filter node configured to refine the dataset by including only fulfilled orders. The filter node allows the user to specify conditions directly via the graphical user interface (GUI), 104a ensuring that only relevant records proceed through the pipeline, minimizing unnecessary data processing.

Further, as illustrated in FIG. 5c, a transformer node is employed to add a derived column to the dataset, calculating the last day of the month for each order date. The derived column represents the month during which each order was placed, for subsequent aggregations. The transformer node allows the user to define custom transformations, such as date manipulation, without writing complex code, thus simplifying the transformation process.

Following this, as illustrated in FIG. 5d, the aggregate node performs key operations such as summing the purchase amounts, adding up redeemed discounts, and counting the number of orders placed by each customer on a monthly basis. The aggregation operations are executed based on the derived month column created in the transformer node, and the results are grouped by the customer ID, enabling users to analyze customer behavior at a monthly level.

Once the aggregation is complete, as illustrated in FIG. 5e, a join node is utilized to enhance the aggregate data by linking it with customer information. The join operation is based on the customer key, ensuring that customer metadata (such as names and locations) is associated with the monthly sales data. The join node simplifies the process of merging datasets by automatically suggesting optimal join keys based on the structure of the input data, thus improving accuracy and reducing manual effort.

After completing the transformations, the pipeline proceeds to a storage phase, where the processed data is stored in a new table named “AGG_FACT_SALES” as illustrated in FIG. 5f. This step ensures that the transformed, aggregated data is readily available for further analysis or reporting.

Finally, FIG. 5g illustrates a code snippet of the generated DBT model, illustrating how the low-code framework automatically converts the visual pipeline design into optimized and reusable DBT models. These models can be applied across multiple datasets or transformation processes with minimal modification, further enhancing the efficiency and scalability of the data transformation system.

The method and system is advantageous in that it leverages artificial intelligence (AI) to assist users in generating DBT models swiftly and optimally. By integrating AI capabilities into the data transformation workflow, the method and system significantly reduces the manual effort and technical expertise typically required to create efficient DBT models. Users can interact with a user-friendly graphical interface that simplifies the pipeline design process, allowing for intuitive drag-and-drop functionality and other input methods.

Advantageously, the method and system provides an ability to design a pipeline with multiple target nodes which significantly enhances the efficiency of data processing workflows. By identifying common sets of transformations and placing them within intermediate models, the method and system enables the reuse of the transformations across various target nodes. This approach not only eliminates redundant computations, thereby reducing overall processing time and resource consumption, but also simplifies the pipeline design.

As a result, users can achieve greater efficiency and consistency in their data transformations, ensuring that transformations are applied uniformly across different targets. This leads to improved performance, faster turnaround times, and a more streamlined workflow. This capability enables users to optimize their data pipelines, maximizing the value derived from their data processing efforts while minimizing unnecessary computational overhead.

By providing easy access to a common set of transformation operations, the DBT storage module not only enhances the efficiency of pipeline design but also promotes collaboration among users. Team members can share and leverage each other's work, fostering a culture of knowledge sharing and continuous improvement. Additionally, the ability to reuse intermediate models ensures that teams can maintain consistency in their data transformation practices, which is critical for ensuring data quality and reliability.

The method and system offers a low-code AI-based experience for designing DBT-compatible data pipelines, significantly lowering the barrier to entry for users, including those without extensive programming knowledge. The intuitive interface streamlines the process of pipeline creation, enabling users to focus on their data strategies rather than getting bogged down in complex coding tasks.

The platform's capability to identify intermediate models that can be repurposed across multiple targets within the same pipeline provides a significant advantage in enhancing operational efficiency and resource utilization. By recognizing and reusing these intermediate models, users can avoid redundant computations and streamline their workflows, leading to faster processing times.

This approach not only minimizes the computational burden but also simplifies the overall pipeline architecture, making it easier to manage and maintain. As a result, users can achieve greater consistency in their data transformations, ensuring that outputs remain aligned across various target nodes. Additionally, the ability to repurpose intermediate models fosters innovation and flexibility, allowing users to quickly adapt their pipelines to evolving data requirements and business needs.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A system for enabling a user to generate reusable data build tool (DBT) models using a low-code framework, the system comprising:
a graphical user interface (GUI) configured to enable a user to design a data transformation pipeline that transforms a source dataset into one or more target datasets, the data transformation pipeline comprising a plurality of processing nodes, wherein each processing node represents a specific transformation function and allows user-defined parameters;
a pipeline validation module configured to validate the data transformation pipeline, wherein the validation comprises checking configuration settings, verifying key settings, and detecting errors within the data transformation pipeline through automated analysis;
an optimization engine operatively coupled to the pipeline validation module, the optimization engine applying optimization algorithms to improve the efficiency of the data transformation pipeline; and
a code generation module configured to generate one or more reusable DBT models corresponding to the data transformation pipeline.

2. The system of claim 1, wherein the GUI is further configured to provide real-time feedback to the user regarding the validity of processing nodes and connections as the user designs the data transformation pipeline, including visual indicators for errors or warning.

3. The system of claim 1, wherein the pipeline validation module is configured to provide validation error messages to the user via the GUI.

4. The system of claim 1, wherein the plurality of processing nodes comprises transformation operations selected from the group consisting of a join operation, a filter operation, an aggregation operation, and a union operation, with each transformation operation defined by a set of parameters editable via the GUI.

5. The system of claim 1 further comprising a DBT storage module configured to identify and store a common set of transformation operations from the data transformation pipeline in intermediate models for reuse for one or more target datasets, wherein the DBT storage module generates a metadata catalog to facilitate selection of common operations based on past user designs.

6. The system of claim 5, wherein a rule metrics module is configured to analyze the common set of transformation operations and maintain a dynamic database of optimization rules that suggest optimal groupings and sequences for the identified transformation operations based on performance data from previous executions.

7. The system of claim 1, wherein the optimization engine is configured to optimize the data transformation pipeline by generating recommendations to the user for adjusting processing nodes or by automatically reordering the transformation operations based on historical performance metrics to optimize execution time.

8. A computer implemented method for enabling a user to generate reusable data built tool (DBT) models using a low-code framework, the method comprising:
enabling a user to design a data transformation pipeline, via a graphical user interface (GUI), that transforms a source dataset into one or more target datasets, the data transformation pipeline comprising a plurality of processing nodes, wherein each processing node represents a specific transformation function and allows user-defined parameters;
validating the data transformation pipeline, wherein the validation comprises checking configuration settings, verifying key settings, and detecting errors within the data transformation pipeline through automated analysis;
improving the efficiency of the data transformation pipeline by applying optimization algorithms; and
generating one or more reusable DBT models (106) corresponding to the data transformation pipeline.

9. The method of claim 8, wherein the GUI is further configured to provide real-time feedback to the user regarding the validity of processing nodes and connections as the user designs the data transformation pipeline, including visual indicators for errors or warning.

10. The method of claim 8, wherein the plurality of processing nodes comprises transformation operations selected from the group consisting of a join operation, a filter operation, an aggregation operation, and a union operation, with each transformation operation defined by a set of parameters editable via the GUI.

11. The method of claim 8 further comprising a DBT storage module configured to identify and store a common set of transformation operations from the data transformation pipeline in intermediate models for reuse for one or more target datasets, wherein the DBT storage module generates a metadata catalog to facilitate selection of common operations based on past user designs.

12. The method of claim 11, wherein a rule metrics module is configured to analyze the common set of transformation operations and maintain a dynamic database of optimization rules that suggest optimal groupings and sequences for the identified transformation operations based on performance data from previous executions.
